(19) United States
(12) Patent Application Publication
(10) Pub. No.: US 2004/0240208 A1
(43) Pub. Date: Dec. 2, 2004

(54) Lumen sensing system

(75) Inventor: Denny D. Beasley, Cincinnati, OH (US)

Correspondence Address: WOOD, HERRON & EVANS, LLP, 2700 CAREW TOWER, 441 VINE STREET, CINCINNATI, OH, 45202, US

(73) Assignee: Delta Power Supply, Inc.

(21) Appl. No.: 10/452,367

(22) Filed: Jun. 2, 2003

(51) Int. Cl. F21V 1/00

(52) U.S. Cl. 362/276

(57) ABSTRACT

A method and apparatus suited to operate a lamp in a manner that addresses the problems of the prior art. The luminosity at each lamp is individually monitored to maintain an optimum lumen level for the lamp. The sensor used to monitor the lamp is powered by the same light source(s) it detects.

### FIELD OF THE INVENTION

This invention is directed generally to luminary technologies, and more particularly, to the operation and monitoring of HID ballasts.

### BACKGROUND OF THE INVENTION

Efficiency, compatibility and longevity considerations have become ubiquitous within the artificial lighting industry and consumer base. To this end, manufacturers of incandescent, fluorescent and high-intensity (HID) light sources allocate substantial resources to improve operation of their mercury vapor, metal halide, high and low pressure sodium lamps. The relatively low power consumption and light color features associated with such sources have made HID lighting systems commonplace in factories, schools, retail stores, industrial buildings, studios, malls and street settings.

Unlike conventional incandescent lamps that may be powered directly from a 120 V/60 Hz utility source, HID lamps require a ballast for the ignition and subsequent operation of the lamp. Such operation typically includes regulating the flow of electrical current to the lamp. One purpose of such regulation may be to achieve a desired level of illumination in a lighting environment.

Despite the efficiencies associated with HID lamps, maintaining the desired light level is complicated by the fact that lumen output for the lamps decreases over time. That is, lumen output from a lamp decreases proportionately to the duration of the lamp's use. As a consequence, a light designer typically configures a lamp to initially have a lumen output that substantially exceeds its rated mean lumen value.

This initial, elevated setting is conventionally required to anticipate and correct for the lumen output depreciation. For instance, the initial lumen output of the lamp may be set at a level that tolerates 8,000 hours of use before falling below the mean lumen value. The effect of this practice, however, is to provide more lumen output at the beginning of a lamp's life than is needed, and too little near the end of the lamp's life. Moreover, initially generating the elevated lumen output wastes power and unduly burdens lamp circuitry, leading to decreased lamp life. Consequently, what is needed is an improved process for operating a lamp.

### SUMMARY OF THE INVENTION

The present invention provides in one respect a method and apparatus suited to operate a lamp in a manner that addresses the problems of the prior art. The luminosity at each lamp is individually monitored at each lamp to maintain an optimum lumen level at that lamp. In one embodiment, the sensor used to monitor the lamp is powered at least in part by the same light source(s) it detects. For instance, the sensor may detect light energy generated by either or both the lamp and ambient light.

Control circuitry in communication with the sensor may impart a control signal to the ballast indicative of the sensed output level. To this end, the sensor may comprise a photovoltaic cell. The control signal may cause the slope of the power curve for the lighting system of the present invention to remain generally flat. That is, the lighting level may remain relatively constant. To this end, the control signal may initiate in an increase in lumen output in response to the detected light level falling below some predetermined threshold set by a user. Conversely, lumen output from the lamp may be decreased where the detected light level exceeds the threshold.

The above and other objects and advantages of the present invention shall be made apparent from the accompanying drawings and the following description.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the present invention.

FIG. 1 is a block diagram of a ballast system in accordance with the principles of the present invention;

FIG. 2 is a block diagram of a second ballast system in accordance with the principles of the present invention;

FIG. 3 is a schematic diagram that includes a photovoltaic cell suitable for inclusion within the lighting systems of FIGS. 1 and 2;

FIG. 4 is a schematic diagram that includes a cell and controller suitable for inclusion within the lighting systems of FIGS. 1 and 2;

FIG. 5 is a block diagram of a lighting system that includes series and parallel connected control elements and that is suitable for inclusion within the lighting systems of FIGS. 1 and 2;

FIG. 6 is a graph having control curves;

FIG. 7 is a graph plotting lamp power over control signal voltage;

FIG. 8 shows a block diagram of a lighting system that includes two sensors that detect light from different sources;

FIG. 9 is a flowchart having steps for monitoring and operating a lighting system 10 in a manner that is consistent with the principles of the present invention; and

FIG. 10 is a flowchart having steps that are suited for execution by a microprocessor in a manner that is consistent with the principles of the present invention.

### DETAILED DESCRIPTION OF THE PREFERRED EMBODIMENT

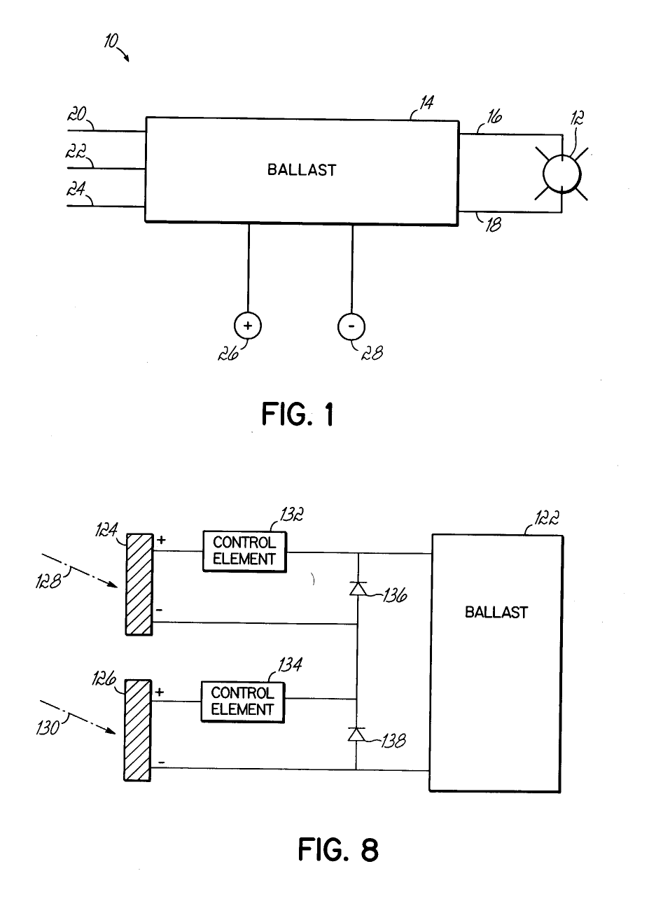

FIG. 1 shows a block diagram of lighting system 10 that is consistent with the principles of the present invention. The system 10 includes a lamp 12 and a ballast 14, as well as respective leads 16-24 connected to the ballast 14 and lamp 12. While features of the present invention may have particular application within the context of HID lamps, one of skill in the art should appreciate that a suitable lamp for purposes of this specification may include any device configured to generate a light output. Also included within the system 10 are control input dimming leads 26 and 28 for dimming the ballast 14. The control input dimming leads 26 and 28 typically comprise about a 0 to about a 10 VDC control port. However, one of skill in the art will appreciate that voltage supplied via leads 26 and 28 is not limited to any particular range.

In one embodiment, the voltage level supplied to the leads 26 and 28 is generated in response to detected luminosity. For instance, the voltage delivered to the leads 26 and 28 may vary as a function of a detected light level. Exemplary sources of the detected light level may include lumen output from the lamp 12 and/or a natural/environmental light level independent of the lamp lumen output.

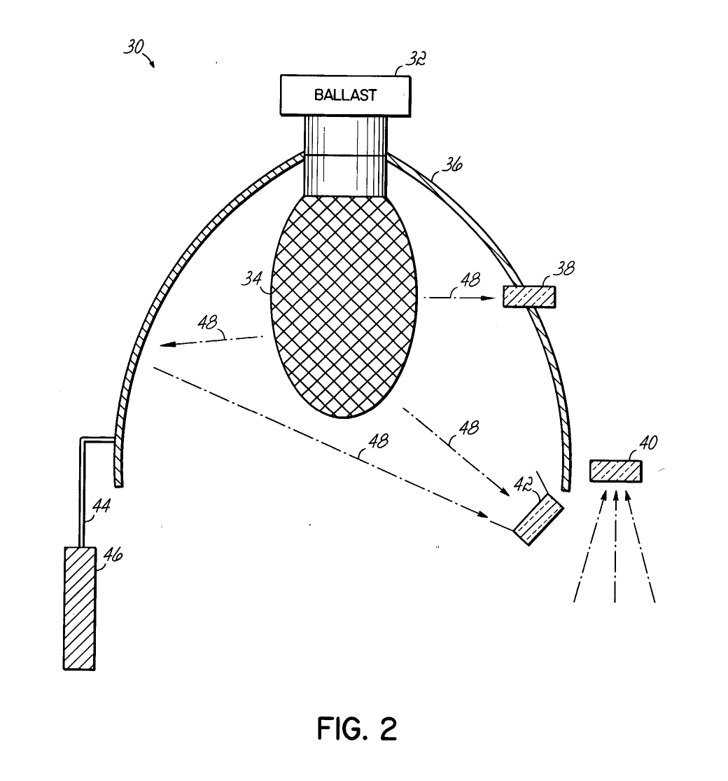

The exemplary lighting system 30 of FIG. 2 includes a plurality of exemplary sensors 38-44, each suited to individually and/or collectively detect a light level. The exemplary sensors 38-44 in FIG. 2 are photovoltaic sensors, however, any device capable of sensing a light output could alternatively be used. The photovoltaic sensors 38-44 shown in FIG. 2 can sense direct and indirect lumen output 48 from a lamp 34, as well as natural/ambient light 48 from other sources. The sensors 38-44 may be powered by energy received and detected by the light 48. The source of the light 48 delivered to the sensors 38-44 may thus include the lamp 12, reflector 36, ambient light sources, and any combination thereof. For instance, a sensor 42 may be positioned such that all or a majority of light received is from the lamp 34. Thus, the sensor's output to the ballast 32 is response to the changes in lamp output, exclusively. To this end, a skirt 47 may be included to direct/shield light towards and away from the sensor 42.

In this respect, the sensors 38-44 may comprise part of a self-contained and powered monitoring system. As desired, sensors 38-44 may be located in a number of positions, including around or within the reflector 36, the walls, ballast 32, floor, ceilings surrounding the lamp 34. Still other suitable locations may be remote from the lamp 34. To this end, the system 30 may include a fiber optic cable 46, mirror, lens or other mechanism useful in communicating light signals remotely to a sensor 44.

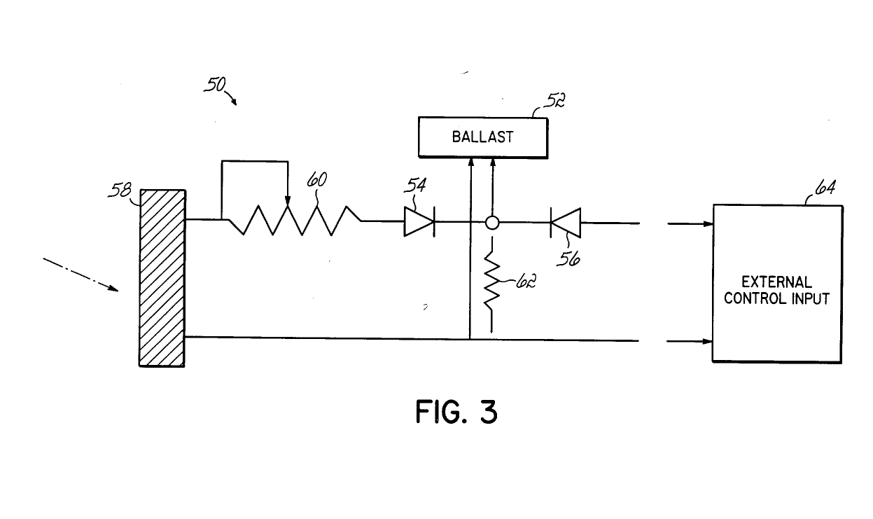

FIG. 3 shows a schematic diagram of a photovoltaic cell 58 suitable for inclusion within the lighting systems 10, 30 or FIGS. 1 and 2, respectively. In one respect, the cell 58 is configured to generate a control signal into the control input dimming lead of a ballast 52. The control signal may be generated in response to light incident on and detected by the photovoltaic cell 50. More particularly, the lighting system 50 of FIG. 3 includes diodes 54 and 56 configured to pass the control signal to the ballast input. Resistance 62 of the schematic of FIG. 3 is representative of the effective resistive load of the ballast control input dimming leads.

When the photovoltaic cell voltage output is less than the external control voltage, input diode 54 is reversed bias and diode 56 becomes forward biased and passes external control to the ballast 52. Alternatively, when the cell voltage exceeds the control volts input plus the forward drop of diode 56 will then reverse bias and the cell 58 will be in control. The effect of the diodes 54 and 56 is to select the highest control voltage or the lowest power setting. At the same time each control voltage source is isolated from one other.

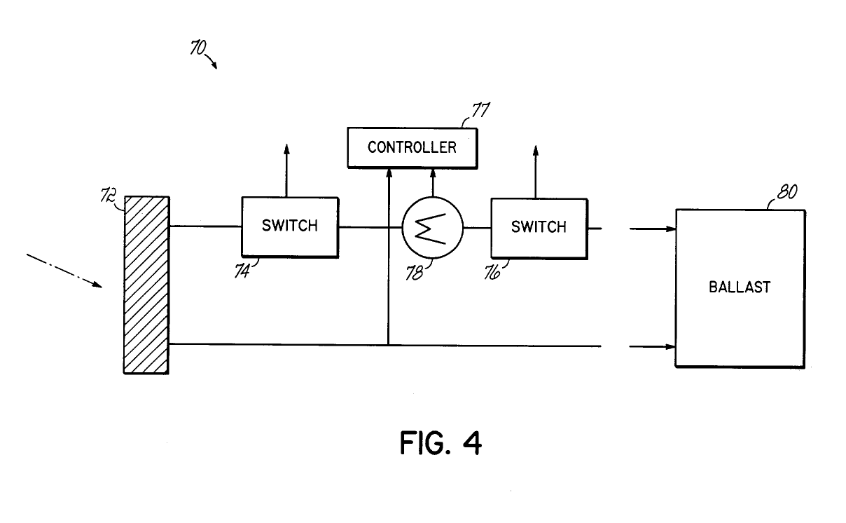

FIG. 4 shows a schematic diagram of alternative circuit embodiment similar to the embodiment of FIG. 3. In the circuit 70 of FIG. 4, functionality of the diodes 54 and 56 of FIG. 3 is replaced with a controller 77. A suitable controller 77 is configured to affect a switch between the cell 58 and a control input. As such, the circuit 70 includes switches 74 and 76 configured to switch between the two power control inputs based on operational criteria.

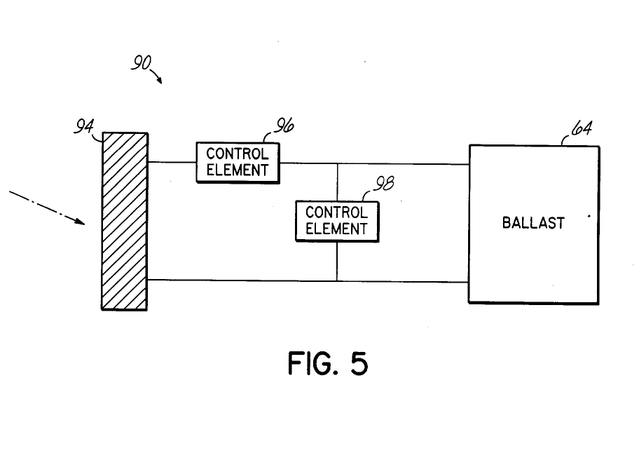

FIG. 5 shows a block diagram of a lighting system 90 that includes series and parallel connected control elements 96 and 98, configured to control, or apportion the signal level of the control input lead of the ballast 92. These control elements 96 and 98 may comprise a resistor and/or an imbedded microcontroller or other processor. The control elements 96 and 98 are configured to adjust the slope of light output of the lamp relative to its hours of use.

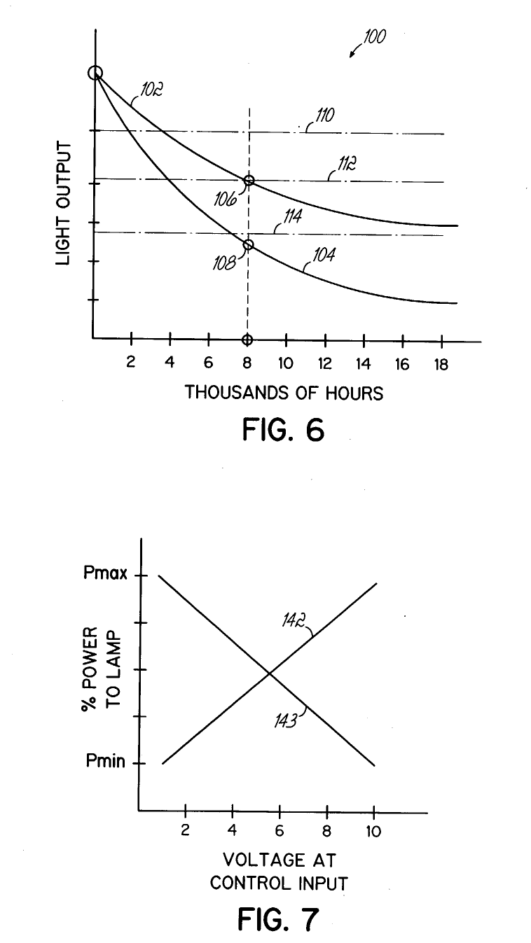

Such slope and control curves 110-114 are shown in the graph 100 of FIG. 6. These control curves 110-114 contrast the conventional lumen depreciation curves 102 and 104 of prior art gas discharge lamps, which are shown for illustrative purposes. While the prior art control curves 102 and 104 lose lumen output capacity relatively quickly, the more flat, controlled curves 110-114 possible with the lighting system of the present invention may allow the lamp to operate at an underpowered state for most of its life, extending the duration of its utility.

Where desired, the slope of the control curves 110-114 may be generally flat, and light levels may be factory preset to a value desired by the user. As depreciation factors are detected, the control signals of the present invention may cause the power delivered to the lamp to increase in order to keep the light level of the lamp and/or illumination area at predetermined level. Conversely, power may be increased as desired in response to detected conditions and/or user specifications.

The graph 140 of FIG. 7 shows this relationship between power delivered to the lamp via the ballast on the y-axis as plotted against the voltage of the control signal generated by one or more sensors along the x-axis. Ballast curve 142 is representative of an exemplary positive control slope, while ballast curve 143 shows characteristics of a negative control slope.

FIG. 8 shows a block diagram of a lighting system 120 that includes two sensors 124 and 126 that detect light from different sources. The first sensor 124, for example, may detect direct light output of a lamp, while the second sensor 126 may detect indirect light reflected by the reflector. The circuitry included in the block diagram of FIG. 8 is useful in adjusting the output of the respective sensors 124 and 126 and control elements 136 and 138 to manipulate sensor voltage to yield different control slopes.

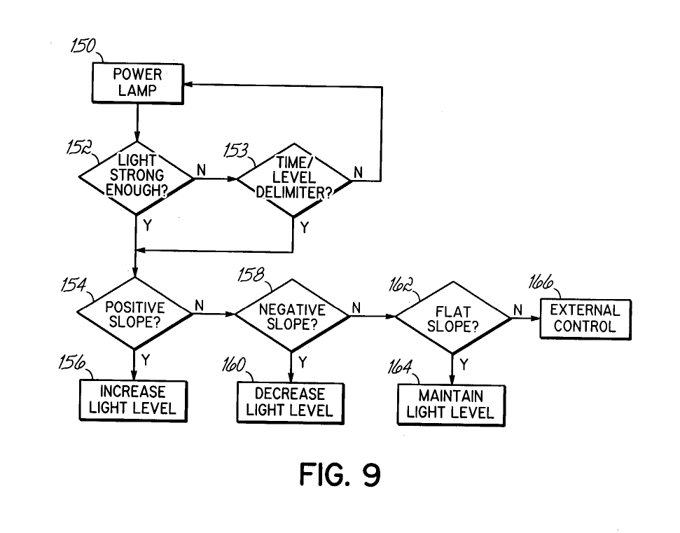

FIG. 9 is a flowchart having steps for monitoring and operating a lighting system 10 in a manner that is consistent with the principles of the present invention. At block 150, operation of the lamp 12 is initiated. Once the lumen output has achieved a level sufficient to stimulate a photovoltaic cell 38 at block 152 and/or a time/level delimiter condition is determined at block 153, then the system 10 determines what slope is desired. As discussed herein, this slope determination may account for either or both of user specifications and detected luminosity.

As such, system 10 may determine at block 154 that a positive slope is appropriate. Accordingly, the lumen output of the lamp 12 may be made to increase at block 156 on an hour-by-hour or day-by-day basis to compensate for changes in ambient reflectivity, for instance. Alternatively, the system 10 may implement a negative slope condition at blocks 158, where the lamp output is decreased over time at block 160 by, as above, adjusting power into the lamp 12.

A third alternative at block 162 includes a flat slope condition. Implementation of a flat slope may include dynamically varying the power to the ballast to maintain a current light level at block 164. As discussed herein, such a current light level may include both ambient and lamp-generated light. Where so configured, a system 10 may allow for external control at block 166. Such external control may allow a user of one embodiment to override program protocol to initiate a minimum or maximum dimming operation, for example.

One of skill in the art should appreciate that any of the hardware implementations of the present invention could be realized using software where appropriate. For instance, the functionality of any of the circuitry included within the hardware systems described above may be supplanted and/or augmented with programs executed by embedded microchip or other technologies. Moreover, such processors may be powered by energy harvested from the photovoltaic cells where appropriate.

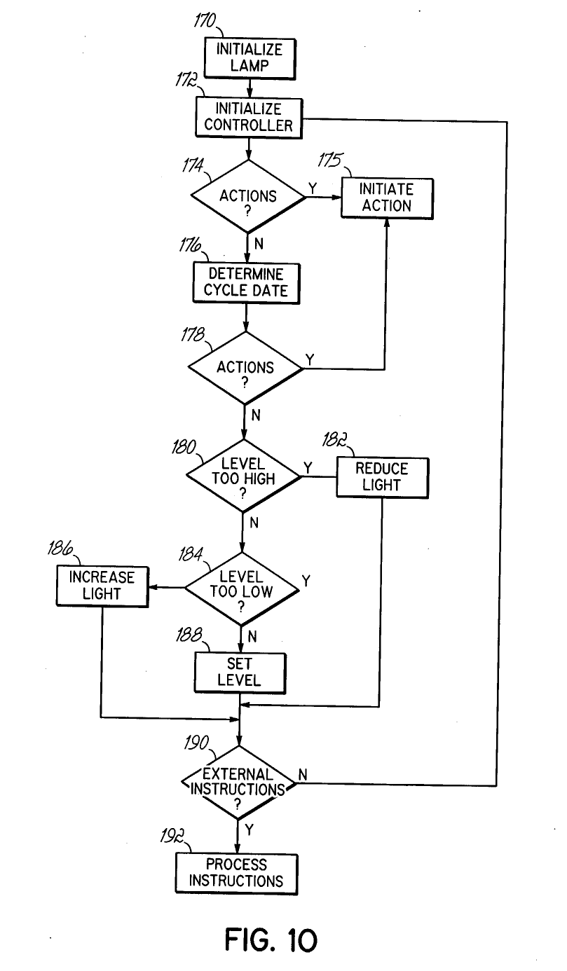

The flowchart of FIG. 10 illustrates exemplary steps that are suited for execution by such a microprocessor in a manner that is consistent with the principles of the present invention. Turning the flowchart, the lamp 12 is initialized at block 170. Activation of the lamp 12 at block 172 may initialize the controller/microprocessor at block 172. Such initialization processes may include checking for previous cycle instructions and/or diagnostic flags. Such instructions may include previous dimming protocols from a previous cycle. For instance, a “no dim” command may prevent dimming from occurring during a subsequent cycle. A “new instruction” command may convey a new a new dimming template or other instruction for execution by the system 10. Exemplary diagnostic flags may include data pertaining to the operational status of a lamp 12. For instance, a flag detected by the controller at block 172 may indicate that a lamp 12 may be malfunctioning.

The system 10 may initiate an action based upon a detected instruction or diagnostic flag at block 174. For instance, the controller may cause a user to be notified of a potentially malfunctioning lamp 12 at block 175. Such may be the case where too many cycles are detected at block 176 within too short a period. The controller may alternatively execute the new dimming instructions of bock 175.

At block 176, the system 10 may determine cycle data regarding the lamp 12. For instance, the system 10 may determine if this is the first time that the controller has ever been activated. Alternatively, the system 10 may determine and record the total number of times that a routine has been activated. Such knowledge may help apprise a user of the aging characteristics of the lamp 12. The number of on/off cycles may further be determined at block 176 and compared against an allowed use template. If not, then a special action may be initiated at blocks 178 and 175 that may include shutting down the lamp 12, the system 10, turning on a flag/indicator and/or initiating a warning signal to a user, as above.

The system 10 may monitor the light level at blocks 180, 184 and 188 to ensure optimum lamp performance. For instance, the controller may determine at block 180 if the lumen output exceed a predetermined level. If so, the controller may alter the current to the ballast to affect reduced lumen output over a preset period. Alternatively, the controller may increase the light level or leave it unaltered should it be determined that the light level detected by a sensor is too low or at the predetermined level, respectively. One of skill in the art will appreciate that the controller is well suited to respectively receive and execute any external instructions affecting system 10 operation at blocks 190 and 192.

Moreover, while the present invention has been illustrated by a description of various embodiments, and while these embodiments have been described in considerable detail, it is not the intention of the applicants to restrict or in any way limit the scope of the appended claims to such detail. Additional advantages and modifications will readily appear to those skilled in the art. For instance, embodiments consistent with the invention may include a system configured to detect and monitor filtered light using a sensor responsive to certain wavelengths of the visible spectrum. Thus the power would be controlled on color and not totalized energy levels received in a wide spectrum light at the sensor.

In another embodiment, the sensor may be physically remote from a photovoltaic cell used to power. Still another embodiment may regulate power to a controller using boost or buck topologies know in the art. Storage of power may be achieved by use of super-capacitors (very high capacitance capacitors suitable for energy storage) or batteries. This can allow for the orderly shut down when the light is turned off as well as provide a time when the controller can record the number of events. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. An apparatus comprising a plurality of HID lamps comprising:
a ballast coupled to each HID lamp and configured to deliver power to each HID lamp; and
a sensor coupled to each HID lamp and to the ballast, wherein the sensor communicates a control signal to the ballast that determines the delivered power to the HID lamp.

2. The apparatus of claim 1, wherein the sensor is a photovoltaic cell.

3. The apparatus of claim 1, wherein the sensor is powered by light energy.

4. The apparatus of claim 3, wherein the light energy is generated from at least one source selected from a group consisting of: ambient light and lamp output.

5. The apparatus of claim 1, wherein the apparatus further includes a controller in communication with the ballast.

6. The apparatus of claim 1, wherein the control signal ranges from about 0 volts to about 10 volts in magnitude.

7. An apparatus comprising:
a lamp configured to output lumen;
a ballast coupled to the lamp and configured to supply power to the lamp;
a sensor configured to detect the output lumen, wherein the sensor is at least in part powered by the output lumen.

8. The apparatus of claim 7, wherein the sensor is further powered in part by ambient light energy.

9. The apparatus of claim 7, wherein the sensor sends a control signal to the ballast in response to the output lumen.

10. The apparatus of claim 7, wherein the ballast generally maintains a constant light level.

11. The apparatus of claim 7, wherein the sensor includes a skirt.

12. The apparatus of claim 7, wherein the sensor includes at least one component selected from a group consisting of: a controller, a battery, a capacitor, a diode, fiber optic material, a switch, a photovoltaic cell.

13. The apparatus of claim 7, wherein the output lumen is increased in response to the detected lumen output exceeding a predetermined level.

14. The apparatus of claim 7, wherein the output lumen is decreased in response to the detected lumen output falling short of a predetermined level.

15. A method of operating a ballast comprising:
sensing a lumen output from a lamp with a sensor powered at least in part by the lumen output;
adjusting the lumen output in accordance with a control signal from the sensor.

16. The method of claim 15, further comprising sensing ambient light with the sensor.

17. The method of claim 15, wherein adjusting the lumen output further comprises sending a control signal to the ballast in response to the sensed lumen output.

18. The method of claim 15, further comprising maintaining a constant light level.

19. The method of claim 15, further comprising initiating an action in response to detecting a cycle abnormality.

20. The method of claim 15, further comprising determining faulty lamp operation.

21. The method of claim 15, further comprising increasing the lumen output in response to the sensed lumen output exceeding a predetermined level.

22. The method of claim 15, further comprising decreasing the lumen output in response to the detected lumen output falling short of a predetermined level.

23. A method of operating a plurality of HID lamps comprising:
adjusting a lumen output of a HID lamp of a plurality of HID lamps, wherein each HID lamp of the plurality includes a sensor in communication with the a respective HID lamp.

24. The method of claim 23, further comprising detecting a light level using the sensor.

25. The method of claim 23, further comprising powering the sensor using the lumen output.

26. The method of claim 23, wherein adjusting the lumen output further comprises generating a control signal in response to detected light energy.

27. The method of claim 23, further comprising determining cycle data.

28. The method of claim 23, further comprising setting a predetermined level.
